(19) United States
(12) Patent Application Publication
(10) Pub. No.: US 2014/0313394 A1
(43) Pub. Date: Oct. 23, 2014

(54) ZOOM LENS AND IMAGING APPARATUS EMPLOYING THE SAME

(71) Applicant: SAMSUNG ELECTRONICS CO., LTD., Suwon-si (KR)

(72) Inventor: Jin-woo Kim, Yongin-si (KR)

(73) Assignee: SAMSUNG ELECTRONICS CO., LTD., Suwon-si (KR)

(21) Appl. No.: 14/063,227

(22) Filed: Oct. 25, 2013

(30) Foreign Application Priority Data
Apr. 19, 2013 (KR) 10-2013-0043814

(51) Int. Cl. G02B 13/00

(52) U.S. Cl. CPC G02B 13/009
USPC 348/345; 359/687; 359/557

(57) ABSTRACT

A zoom lens includes, in an order from an object side to an image surface side: a first lens group having positive refractive power and including a negative lens and a positive lens; a second lens group having negative refractive power and including a negative lens having a meniscus shape concave to the image surface side; a third lens group having positive refractive power and including an aspherical lens having at least one aspherical surface; and a fourth lens group having positive refractive power. During zooming from a wide angle position to a telephoto position, the first through fourth lens groups all move, and the third lens group moves from the image surface side to the object side and then back to the image surface side.

### CROSS-REFERENCE TO RELATED PATENT APPLICATION

This application claims the priority benefit of Korean Patent Application No. 10-2013-0043814, filed on Apr. 19, 2013, in the Korean Intellectual Property Office, the disclosure of which is incorporated herein in its entirety by reference.

### BACKGROUND

1. Field

Various embodiments of the invention relate to a zoom lens and an imaging apparatus, which are used in a sub-miniature camera, a digital video camera, a mobile phone, or an information portable terminal, such as a personal digital assistant (PDA).

2. Related Art

Recently, the number of optical image-forming devices (e.g., digital cameras or digital camcorders) using a solid-state image pickup device, such as a charge-coupled device (CCD) or a complementary metal-oxide semiconductor (CMOS) image sensor, has rapidly increased, and the devices have been sold and distributed. Accordingly, a zoom lens having a high performance and a small and lightweight structure is required.

In the market of an optical system using the solid-state image pickup device, the optical system needs to achieve not only high resolution but also high magnification while being small and lightweight. Also, the technical expertise of consumers of cameras is continuously increasing.

In order to achieve high magnification in the zoom lens, first through fourth lens groups respectively having positive, negative, positive, and positive refractive powers may be used. A trajectory of the third lens group tends to be in only one direction from an image side to an object side, while each of the first through fourth lens groups moves individually during zooming. In this case, a moving distance of the third lens group is increased, thereby increasing a total length of a lens system, and thus it may be difficult to miniaturize the lens system. In addition, due to the shapes of lenses included in the lens system, it may be difficult to miniaturize the lens system or produce the lens system using a low priced material, such as plastic.

### SUMMARY

One or more embodiments of the invention provide a zoom lens that achieves excellent optical performance, is miniaturized, and is capable of performing hand shake compensation.

According to an embodiment, a zoom lens includes, in an order from an object side to an image surface side: a first lens group having positive refractive power and including a negative lens and a positive lens; a second lens group having negative refractive power and including a negative lens having a meniscus shape concave toward the image surface side; a third lens group having positive refractive power and including an aspherical lens having at least one aspherical surface; and a fourth lens group having positive refractive power. During zooming from a wide angle position to a telephoto position, the first through fourth lens groups all move, and the third lens group moves from the image surface side to the object side and then back to the image surface side. The zoom lens satisfies the following conditions: 60≦Vd3 and 2.9≦f4/fw≦5.6, where Vd3 denotes an Abbe's number of the aspherical lens of the third lens group, f4 denotes a focal length of the fourth lens group, and fw denotes a total focal length of the zoom lens in the wide angle position.

The zoom lens may further satisfy the following condition: 4.5≦ToI/(ft/fw)≦5.5, where ToI denotes a distance from a lens surface of the first lens group closest to the object side to a lens surface of the third lens group closest to the image surface side in the telephoto position, ft denotes a total focal length of the zoom lens in the telephoto position, and fw denotes the total focal length of the zoom lens in the wide angle position.

The zoom lens may further satisfy the following condition: 20≦Pvd−Nvd, where Pvd denotes an Abbe's number of the positive lens of the first lens group and Nvd denotes an Abbe's number of the negative lens of the first lens group.

The negative lens having the meniscus shape of the second lens group may be formed of a plastic material.

The second lens group may further include a positive lens that satisfies the following condition: 2.0≦Nd2, where Nd2 denotes a refractive index of the positive lens of the second lens group.

The second or the third lens group may be configured as a shift lens group that moves in a direction perpendicular to an optical axis for hand shake compensation.

The third lens group may further include a cemented lens formed by cementing two lenses together, each lens having a meniscus shape convex toward the object side.

The fourth lens group may include a lens formed of a plastic material.

The positive lens and the negative lens of the first lens group may form a cemented lens.

The second lens group may further include an aspherical lens having negative refractive power.

The fourth lens group may include an aspherical lens having positive refractive power.

The aspherical lens of the fourth lens group may have a meniscus shape concave toward the object side.

According to another embodiment, a zoom lens includes, in an order from an object side to an image surface side: a first lens group having positive refractive power and including a negative lens and a positive lens; a second lens group having negative refractive power and including a negative lens having a meniscus shape concave toward the image surface; a third lens group having positive refractive power; and a fourth lens group having positive refractive power. During zooming from a wide angle position to a telephoto position, the first through fourth lens groups all move, the third lens group moves from the image surface side to the object side and then back to the image surface side. The zoom lens satisfies the following conditions: 2.9≦f4/fw≦5.6; and 4.5≦ToI/(ft/fw)≦5.5, where f4 denotes a focal length of the fourth lens group, ToI denotes a distance from a lens surface of the first lens group closest to the object side to a lens surface of the third lens group closest to the image surface side in the telephoto position, ft denotes a total focal length of the zoom lens in the telephoto position, and fw denotes a total focal length of the zoom lens in the wide angle position.

The third lens group may include an aspherical lens having positive refractive power and at least one aspherical surface.

### BRIEF DESCRIPTION OF THE DRAWINGS

The above and other features and advantages will become more apparent by describing in detail exemplary embodiments thereof with reference to the attached drawings in which:

FIG. 1 illustrates diagrams of optical arrangements of a zoom lens in a wide angle position, a middle position, and a telephoto position, according to an embodiment;

FIG. 2 is a diagram illustrating movement trajectories of each lens group of the zoom lens of FIG. 1 during zooming;

FIGS. 3A and 3B are diagrams illustrating longitudinal spherical aberrations, astigmatic field curvatures, and distortion aberrations of the zoom lens of FIG. 1 in the wide angle position and the telephoto position;

FIG. 4 illustrates diagrams of optical arrangements of a zoom lens in a wide angle position, a middle position, and a telephoto position, according to another embodiment;

FIG. 5 is a diagram illustrating movement trajectories of each lens group of the zoom lens of FIG. 4 during zooming;

FIGS. 6A and 6B are diagrams illustrating longitudinal spherical aberrations, astigmatic field curvatures, and distortion aberrations of the zoom lens of FIG. 4 in the wide angle position and the telephoto position;

FIG. 7 illustrates diagrams of optical arrangements of a zoom lens in a wide angle position, a middle position, and a telephoto position, according to another embodiment;

FIG. 8 is a diagram illustrating movement trajectories of each lens group of the zoom lens of FIG. 7 during zooming;

FIGS. 9A and 9B are diagrams illustrating longitudinal spherical aberrations, astigmatic field curvatures, and distortion aberrations of the zoom lens of FIG. 7 in the wide angle position and the telephoto position;

FIG. 10 illustrates diagrams of optical arrangements of a zoom lens in a wide angle position, a middle position, and a telephoto position, according to another embodiment;

FIG. 11 is a diagram illustrating movement trajectories of each lens group of the zoom lens of FIG. 10 during zooming;

FIGS. 12A and 12B are diagrams illustrating longitudinal spherical aberrations, astigmatic field curvatures, and distortion aberrations of the zoom lens of FIG. 10 in the wide angle position and the telephoto position; and

FIG. 13 is a diagram of an imaging apparatus, according to an embodiment.

### DETAILED DESCRIPTION

Hereinafter, various embodiments will be described more fully with reference to the accompanying drawings, in which exemplary embodiments are shown. In the drawings, like reference numerals denote like elements, and the sizes of elements may be exaggerated for clarity.

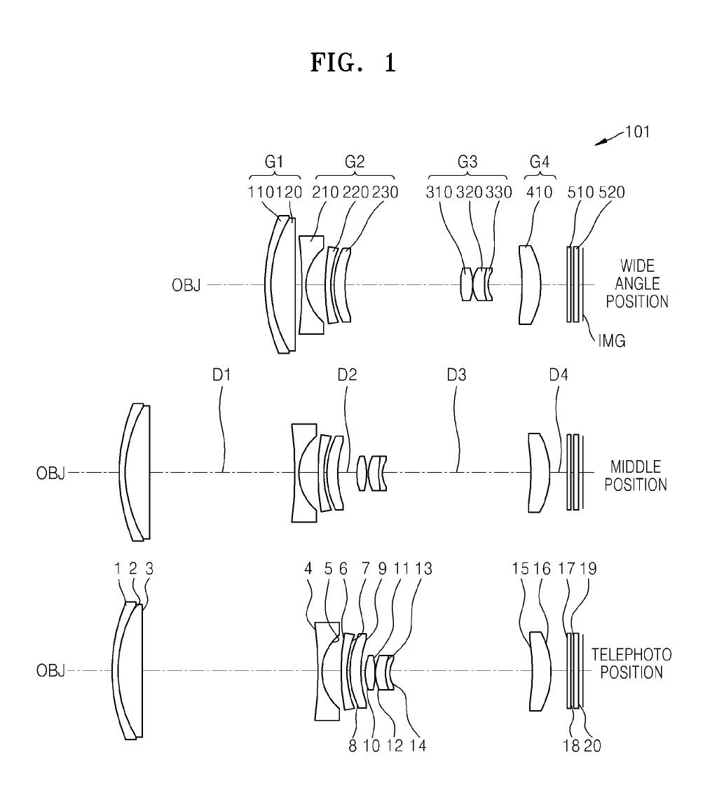

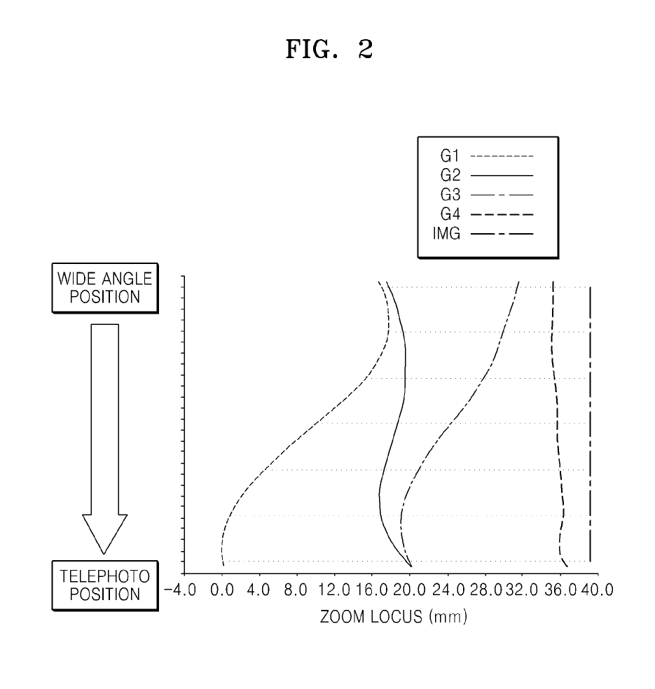

FIGS. 1, 4, 7, and 10 are diagrams of optical arrangements of zoom lenses 101 through 104, respectively, according to various embodiments. FIGS. 2, 5, 8, and 11 are diagrams illustrating movement trajectories of each lens group of the zoom lenses 101 through 104, respectively, during variable zooming/magnification.

The zoom lenses 101 through 104 according to the embodiments include, in an order from an object OBJ side, a first lens group G1 having positive refractive power, a second lens group G2 having negative refractive power, a third lens group G3 having positive refractive power, and a fourth lens group G4 having positive refractive power, so as to achieve miniaturization and high magnification. During zooming from a wide angle position to a telephoto position, the first through fourth lens groups G1 through G4 all move, and the third lens group G3 moves in a trajectory towards the object OBJ side and then back to an image surface IMG side. Such a trajectory of the third lens group G3 is suggested to reduce a total length of an optical system in the telephoto position while maintaining a small F-number in the telephoto position as compared to a magnification change. In a general configuration of four-group zoom lenses, the third lens group moves in a linear trajectory from the image surface IMG side to the object OBJ side. In this case, the total length of the optical system in the telephoto position is too long, and thus the general configuration of four-group zoom lenses is not suitable for miniaturization. Accordingly, the embodiments are directed to lens configurations capable of reducing the total length of the optical system while achieving high magnification.

The zoom lenses 101 through 104 may satisfy condition 1 below.

60≦Vd3 (1)

Here, Vd3 denotes an Abbe's number of an aspherical lens included in the third lens group G3.

The third lens group G3 is used to easily control chromatic aberration by employing an aspherical lens formed of a low dispersive material whose Abbe's number is equal to or higher than 60. When the Abbe's number of the aspherical lens is lower than the lower limit, a low dispersive material has to be used to form a cemented lens included in the third lens group G3, and thus the use of a high refractive index material in the cemented lens may be limited.

The zoom lenses 101 through 104 may satisfy condition 2 below.

2.9≦f4/fw≦5.6 (2)

Here, f4 denotes a focal length of the fourth lens group G4, and fw denotes the total focal length of the zoom lens in the wide angle position.

Condition 2 may be used to suitably maintain focus sensitivity as the fourth lens group G4 has suitable refractive power. When the focal length of the fourth lens group G4, compared to the total focal length of the zoom lenses 101 through 104 in the wide angle position, is lower than the lower limit, the refractive power of the fourth lens group G4 may be too strong and aberration fluctuation may be increased while performing image surface compensation according to an object distance. In a range higher than the upper limit, a movement distance along the optical axis for the image surface compensation may be increased.

The zoom lenses 101 through 104 may satisfy Condition 3 below.

4.5≦ToI/(ft/fw)≦5.5 (3)

Here, ToI denotes a distance from a lens surface of the first lens group G1 closest to the object OBJ side to a lens surface of the third lens group G3 closest to the image surface IMG side in the telephoto position, ft denotes the total focal length of the zoom lenses 101 through 104 in the telephoto position, and fw denotes the total focal length of the zoom lenses 101 through 104 in the wide angle position.

In a range higher than the upper limit, the total optical length of the zoom lenses 101 through 104 in the telephoto position is increased. In order to decrease a size of a lens barrel in which the zoom lenses 101 through 104 are housed, the total optical length of the zoom lenses 101 through 104 in the telephoto position needs to be small. But when the total optical length of a zoom lens in the telephoto position is increased, the size of the body tube housing the zoom lens is also increased. In a range lower than the lower limit, aberration may be difficult to control.

The zoom lenses 101 through 104 may satisfy Condition 4 below.

20≦Pvd−Nvd (4)

Here, Pvd denotes an Abbe's number of a positive lens of the first lens group G1, and Nvd denotes an Abbe's number of a negative lens of the first lens group G1.

Condition 4 is used to control chromatic aberration. When a difference between the Abbe's number of the negative lens of the first lens group G1 and the Abbe's number of the positive lens of the first lens group G1 is lower than the lower limit, it is difficult to control the chromatic aberration.

The zoom lenses 101 through 104 may satisfy Condition 5 below.

2.0≦Nd2 (5)

Here, Nd2 denotes a refractive index of a lens having positive refractive power from the lenses forming the second lens group G2.

For high magnification, the negative refractive power of the second lens group G2 must be high. Accordingly, the positive refractive power of a lens in the second lens group G2 may be strong, and thus a lens having a positive refractive power in the second lens group G2 may be formed of a high refractive index material. For example, a positive lens of the second lens group G2 may be formed of a material whose refractive index is at least 2.0. When the positive lens is not formed of such a material, during high magnification, a movement distance of each lens group is increased during zooming, and a thickness of a lens is increased as a R value of the lens tends to decrease. In other words, the size of the zoom lenses 101 through 104 is increased, and thus productivity and miniaturization may be decreased.

Detailed configurations of each lens group will now be described.

The first lens group G1 may include a first lens 110 that is a negative lens and a second lens 120 that is a positive lens. The first and second lenses 110 and 120 may form a cemented lens. According to such a configuration, the first lens group G1 may suitably control chromatic aberration generated due to high magnification.

The second lens group G2 may include a third lens 210 that is a negative lens, a fourth lens 220 that is a negative lens, and a fifth lens 230 that is a positive lens. The fourth and fifth lenses 220 and 230 may have a meniscus shape convex toward the object OBJ side.

Generally, in four-group zoom lenses, a negative lens close to the image surface IMG side in the second lens group G2 has a biconcave shape or a meniscus shape concave toward the image surface IMG side. However, when the biconcave shape is used, a total thickness of the second lens group G2 is increased, and thus the size of the lens barrel is increased. Also, the biconcave shape is difficult to be formed by using an injection molding method using a plastic material. Accordingly, in the embodiments, a negative lens close to the image surface IMG side in the second lens group G2, i.e., the fourth lens 220, is formed of a plastic material and has a meniscus shape such that the zoom lenses 101 through 104 are miniaturized.

Also, the second lens group G2 may include an aspherical lens having negative refractive power, wherein the fourth lens 220 may be the aspherical lens. The second lens group G2 is a lens group largely affecting adjacent resolving power while increasing a view angle, and easily controls aberration on a non-axis by using an aspherical surface on a negative lens.

For high magnification, the refractive power of the third lens group G3 must be high. Also, in order to maintain a suitable aberration and a small aberration change when the third lens group G3 moves during zooming, the third lens group G3 may include a cemented lens in which two pieces of lenses having a meniscus shape are cemented.

The third lens group G3 may include a sixth lens 310 that is a positive lens, a seventh lens 320 that is a positive lens, and an eighth lens 330 that is a negative lens. The seventh and eighth lenses 320 and 330 may be cemented together to form a cemented lens, where both the seventh and eighth lenses 320 and 330 have a meniscus shape convex toward the object OBJ side, such that a performance change due to high magnification is small.

The third lens group G3 may include an aspherical lens having positive refractive power, wherein the sixth lens 310 may be the aspherical lens. An aperture stop (not shown) may be disposed in the third lens group G3, and for example, may be disposed on a surface of the sixth lens 310 facing the object OBJ side. A spherical aberration may be easily compensated for by using an aspherical surface near the aperture stop.

The second or third lens group G2 or G3 may be configured as a shift lens group moving in a direction crossing an optical axis, for example, in a direction perpendicular to the optical axis, for hand shake compensation. The second or third lens group G2 or G3 configured as the shift lens group may be configured such that a satisfactory image is obtained and a spherical aberration and a Petzval sum are satisfactorily compensated for during a lens shift. Accordingly, an eccentric coma aberration generated at a center of a screen when the spherical aberration and the shift lens group are shifted perpendicular to the optical axis may be suppressed. Also, when the Petzval sum is compensated for, an astigmatic field curvature generated around the screen when the shift lens group moves perpendicular to the optical axis may be suppressed.

Image surface movement and focus location compensation may be performed by the fourth lens group G4 having positive refractive power.

The fourth lens group G4 may include a ninth lens 410 having positive refractive power.

The ninth lens 410 may be an aspherical lens. By forming the fourth lens group G4 with one piece of aspherical lens having positive refractive power, aberration may be satisfactorily controlled and an incident angle of a light ray on an image surface may be satisfactory. A light ray incident on the image surface may have an incident angle that is almost perpendicular to the image surface, i.e., has a small telecentric angle. The ninth lens 410 may have a meniscus shape concave toward the object OBJ side, and thus an astigmatic field curvature may be easily compensated for and an aberration change based on an object distance may be small during focusing. The ninth lens 410 may be formed of a plastic resin material. The fourth lens group G4 has lowest sensitivity among the first through fourth lens groups G1 through G4, and since the ninth lens 410 has a suitable curvature to be formed of a plastic material, material costs may be reduced by using a plastic lens as the ninth lens 410.

An infrared cut-off filter 510 and a cover glass 520 may be disposed at the image IMG side of the fourth lens group G4.

Lens data of each lens group will now be described according to the embodiments.

An aspherical surface shown in the lens data is defined as follows:

$$x = \frac{{c}^{′} {y}^{2}}{1 + \sqrt{1 - ( K + 1 ) {c}^{′2} {h}^{2}}} + A {h}^{4} + B {h}^{6} + {Ch}^{8} + {Dh}^{10}$$

Here, x denotes a distance from a vertex of a lens to an optical axis direction, y denotes a distance in a direction perpendicular to an optical axis, K denotes a conic constant, A, B, C, and D denote aspherical coefficients, and c′ denotes an inverse of a radius of curvature (1/R) at the vertex of the lens.

In the lens data, STOP denotes an aperture stop, f denotes a total focal length of a zoom lens, Fno denotes an F-number, and 2ω denotes a view angle. Units of a focal length, a radius of curvature, a thickness, and a distance are mm, and a unit of a view angle is degree (°). * indicated after a surface number denotes that the corresponding surface is aspherical.

### First Embodiment

FIG. 1 illustrates diagrams of optical arrangements of the zoom lens 101 in a wide angle position, a middle position, and a telephoto position, according to an embodiment. Lens data of the zoom lens 101 is as follows:
f; 4.42˜35.48˜49.90 Fno; 3.3˜7.0˜6.8 2ω; 84.08˜12.37˜8.76

TABLE 1

| | Radius of | Thickness or | Refractive | Abbe's |
|---|---|---|---|---|
| Surface | Curvature (R) | Distance | Index (nd) | Number (Vd) |
| 1 | 20.381 | 0.65 | 2.001 | 25.46 |
| 2 | 13.879 | 2.75 | 1.690 | 53.00 |
| 3* | −771.905 | D1 | | |
| 4 | −44.876 | 0.40 | 1.804 | 46.50 |
| 5 | 5.544 | 1.80 | | |
| 6* | 12.973 | 0.53 | 1.583 | 58.90 |
| 7* | 7.205 | 0.10 | | |
| 8 | 8.365 | 1.17 | 2.104 | 17.20 |
| 9 | 13.224 | D2 | | |
| 10*(STOP) | 4.610 | 1.13 | 1.553 | 71.68 |
| 11* | −13.793 | 0.10 | | |
| 12 | 4.188 | 1.13 | 1.593 | 68.62 |
| 13 | 7.885 | 0.35 | 1.904 | 31.32 |
| 14 | 2.933 | D3 | | |
| 15* | −248.943 | 2.00 | 1.531 | 56.50 |
| 16* | −8.488 | D4 | | |
| 17 | infinity | 0.21 | 1.517 | 64.20 |
| 18 | infinity | 0.10 | | |
| 19 | infinity | 0.50 | 1.517 | 64.20 |
| 20 | infinity | D5 | | |
| 21 | infinity | D6 | | |

TABLE 2

| | Wide Angle | Middle | Telephoto |
|---|---|---|---|
| | Position | Position | Position |
| D1 | 0.80 | 16.06 | 19.45 |
| D2 | 13.65 | 2.19 | 0.40 |
| D3 | 3.77 | 17.13 | 16.37 |
| D4 | 3.42 | 2.36 | 2.32 |
| D5 | 0.53 | 0.53 | 0.53 |
| D6 | −0.02 | 0.03 | −0.01 |

TABLE 3

| Surface | K | A | B | C | D |
|---|---|---|---|---|---|
| 3 | 0.000000 | 2.645923E−06 | 5.739860E−09 | −8.047244E−11 | 0.000000E+00 |
| 6 | 1.000000 | −2.692605E−03 | 9.674654E−05 | −3.838151E−07 | 1.298362E−08 |
| 7 | −5.800000 | 1.473362E−03 | 4.394789E−05 | 2.051505E−06 | −6.613895E−08 |
| 10 | 1.000000 | 1.776383E−04 | −5.425832E−05 | 1.217328E−06 | 0.000000E+00 |
| 11 | 1.000000 | 5.446967E−04 | −8.868850E−05 | 6.400923E−06 | 0.000000E+00 |
| 15 | 0.000000 | −7.195778E−05 | −4.131262E−05 | 1.465421E−06 | −3.725524E−08 |
| 16 | −10.000000 | 1.056028E−03 | −7.261218E−06 | 6.927309E−07 | −2.692998E−08 |

FIG. 2 is a diagram illustrating movement trajectories of each lens group of the zoom lens 101 of FIG. 1 during zooming.

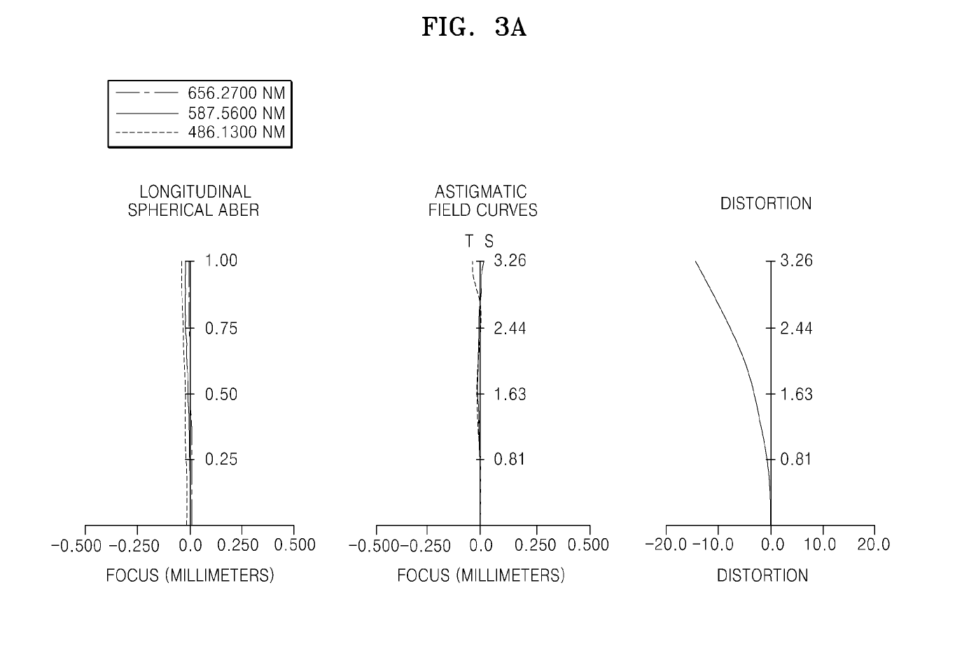

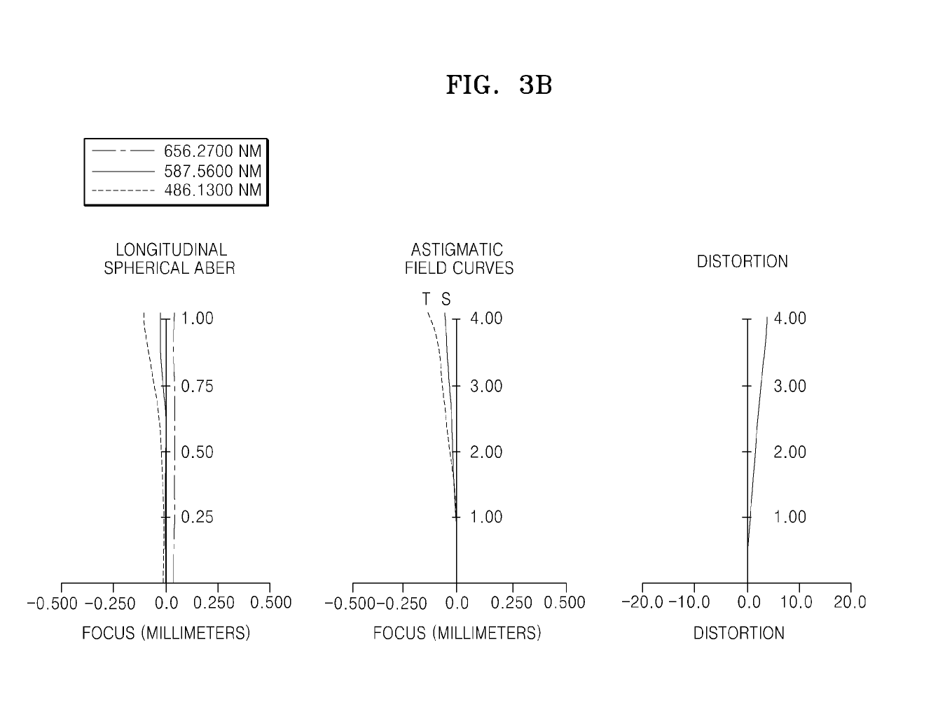

FIGS. 3A and 3B are diagrams illustrating longitudinal spherical aberrations, astigmatic field curvatures, and distortion aberrations of the zoom lens 101 of FIG. 1 in the wide angle position and the telephoto position.

The spherical aberrations are with respect to light rays whose wavelengths are 656.27 nm, 587.56 nm, and 486.13 nm. In the astigmatic field curvatures, T and S respectively denote curvatures on a tangential surface and a sagittal surface.

### Second Embodiment

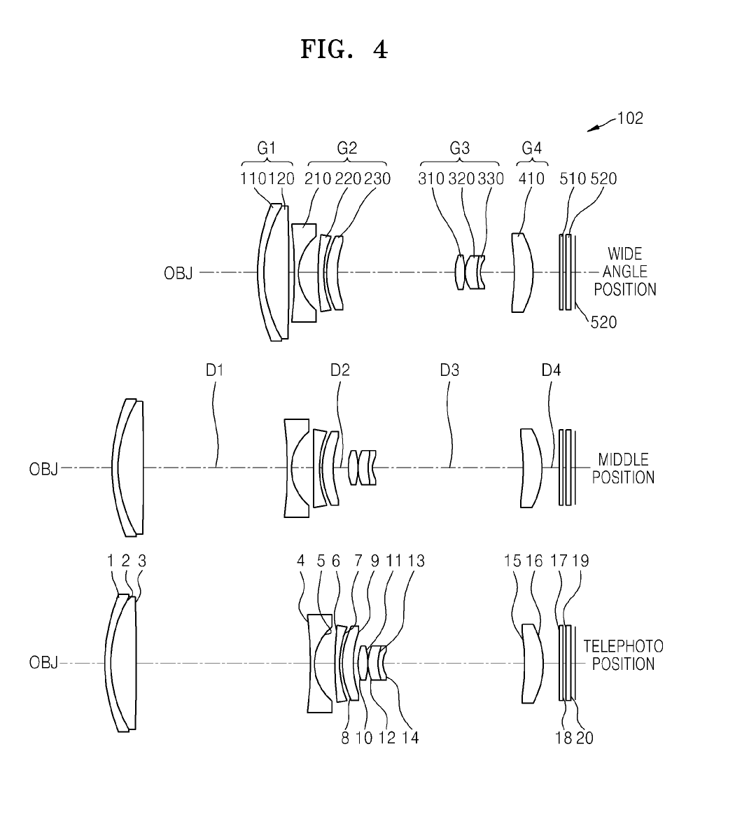

FIG. 4 illustrates diagrams of optical arrangements of the zoom lens 102 in a wide angle position, a middle position, and a telephoto position, according to another embodiment.

f; 4.42˜35.47˜48.59 Fno; 3.35˜7.07˜6.82 2ω; 84.0˜12.30˜8.94

TABLE 4

| | Radius of | Thickness or | Refractive | Abbe's |
|---|---|---|---|---|
| Surface | Curvature (R) | Distance | Index (nd) | Number (vd) |
| 1 | 18.482 | 0.65 | 1.935 | 27.75 |
| 2 | 14.161 | 2.80 | 1.553 | 71.68 |
| 3* | −146.813 | D1 | | |
| 4 | −51.484 | 0.40 | 1.804 | 46.50 |
| 5 | 5.876 | 1.96 | | |
| 6* | 24.108 | 0.53 | 1.583 | 58.90 |
| 7* | 7.780 | 0.10 | | |
| 8 | 7.887 | 1.29 | 2.003 | 19.32 |
| 9 | 14.083 | D2 | | |
| 10*(STOP) | 4.752 | 1.06 | 1.553 | 71.68 |
| 11* | −13.177 | 0.10 | | |
| 12 | 4.382 | 1.31 | 1.593 | 68.62 |
| 13 | 8.693 | 0.35 | 1.904 | 31.32 |
| 14 | 3.007 | D3 | | |
| 15* | −174.864 | 1.67 | 1.531 | 56.50 |
| 16* | −8.079 | D4 | | |
| 17 | infinity | 0.21 | 1.517 | 64.20 |
| 18 | infinity | 0.10 | | |
| 19 | infinity | 0.50 | 1.517 | 64.20 |
| 20 | infinity | D5 | | |
| 21 | infinity | D6 | | |

TABLE 5

| | Wide Angle | Middle | Telephoto |
|---|---|---|---|
| | Position | Position | Position |
| D1 | 0.66 | 16.08 | 19.36 |
| D2 | 13.60 | 2.05 | 0.40 |
| D3 | 4.09 | 17.24 | 16.41 |
| D4 | 3.18 | 2.34 | 2.37 |
| D5 | 0.53 | 0.53 | 0.53 |
| D6 | −0.02 | 0.03 | −0.02 |

TABLE 6

| Surface | K | A | B | C | D |
|---|---|---|---|---|---|
| 3 | 0.000000 | 7.282077E−06 | 4.413973E−09 | −1.047025E−10 | 0.000000E+00 |
| 6 | 1.000000 | −2.258352E−03 | 9.681766E−05 | −5.463409E−07 | −1.180283E−08 |
| 7 | −5.800000 | −1.078610E−03 | 6.398174E−05 | 1.172968E−06 | −6.198603E−08 |
| 10 | 1.000000 | 1.722044E−04 | −4.606884E−05 | 6.397599E−06 | 0.000000E+00 |
| 11 | 1.000000 | 5.686415E−04 | −5.254452E−05 | 7.015482E−06 | 0.000000E+00 |
| 15 | 0.000000 | 1.644838E−04 | −4.994507E−05 | 1.598909E−06 | −4.343115E−08 |
| 16 | −10.000000 | −9.075131E−04 | −6.557590E−06 | 3.400699E−07 | −2.481900E−08 |

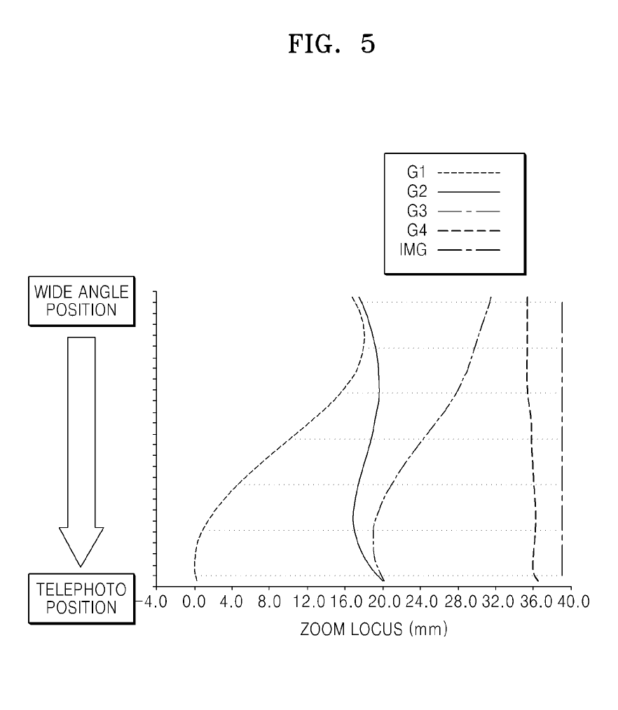

FIG. 5 is a diagram illustrating movement trajectories of each lens group of the zoom lens 102 of FIG. 4 during zooming.

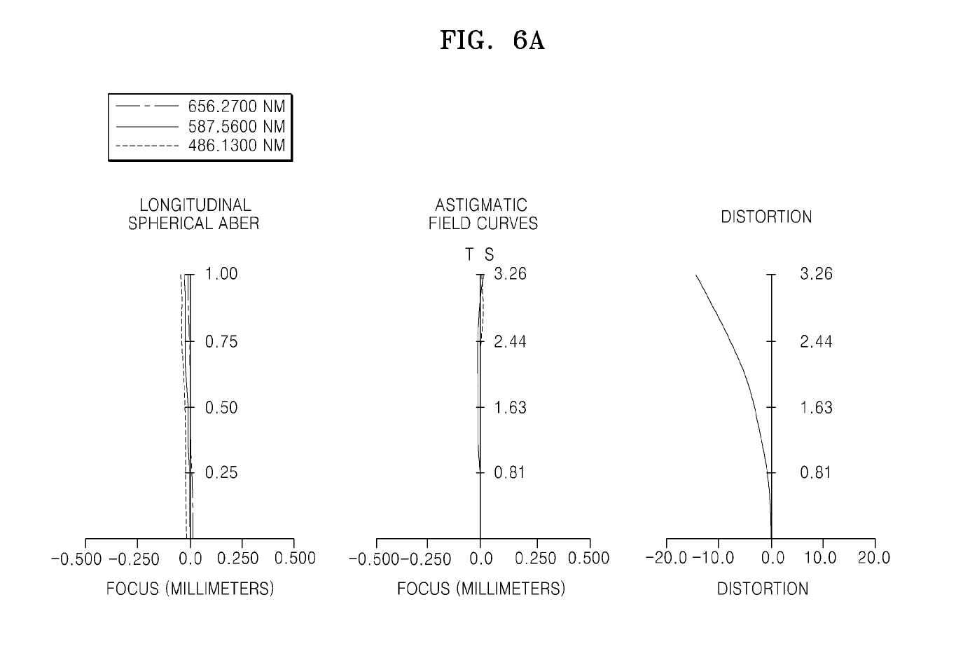

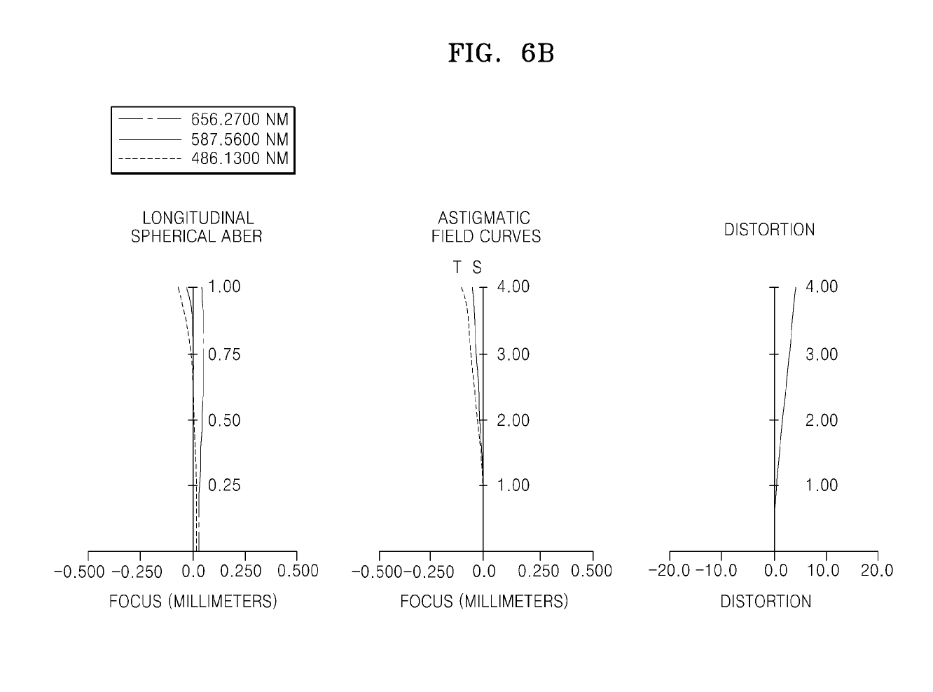

FIGS. 6A and 6B are diagrams illustrating longitudinal spherical aberrations, astigmatic field curvatures, and distortion aberrations of the zoom lens 102 of FIG. 4 in the wide angle position and the telephoto position.

### Third Embodiment

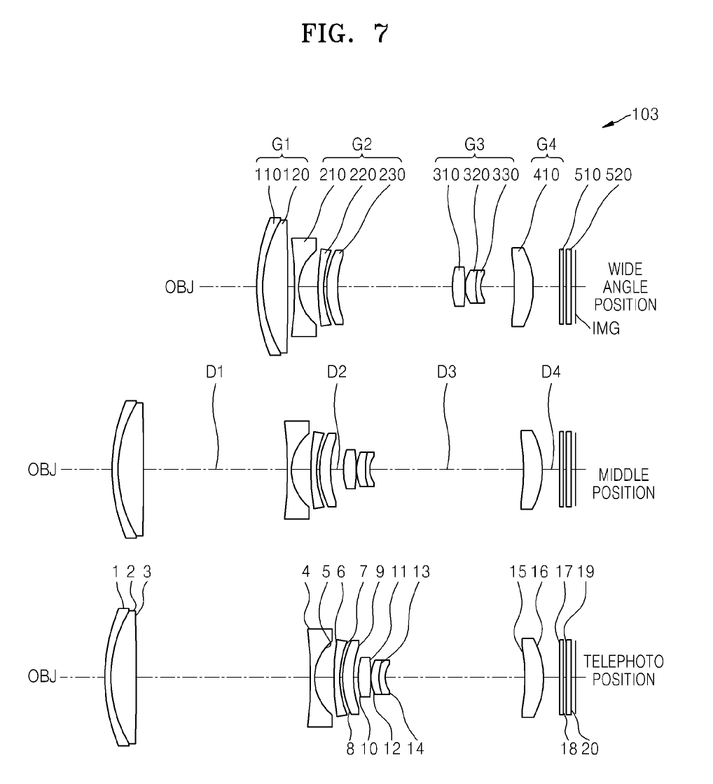

FIG. 7 illustrates diagrams of optical arrangements of the zoom lens 103 in a wide angle position, a middle position, and a telephoto position, according to another embodiment.
f; 4.41˜35.46˜44.17 Fno; 3.23˜6.94˜6.70 2ω; 84.07˜12.29˜9.85

TABLE 7

| | Radius of | Thickness or | Refractive | Abbe's |
|---|---|---|---|---|
| Surface | Curvature (R) | Distance | Index (nd) | Number (Vd) |
| 1 | 19.072 | 0.65 | 2.002 | 29.13 |
| 2 | 14.507 | 2.59 | 1.553 | 71.68 |
| 3* | −126.646 | D1 | | |
| 4 | −43.754 | 0.40 | 1.804 | 46.50 |
| 5 | 5.504 | 1.97 | | |
| 6* | 30.000 | 0.53 | 1.583 | 58.90 |
| 7* | 9.566 | 0.10 | | |
| 8 | 9.580 | 1.23 | 2.003 | 19.32 |
| 9 | 21.168 | D2 | | |
| 10*(STOP) | 4.357 | 1.56 | 1.589 | 61.25 |
| 11* | −15.746 | 0.10 | | |
| 12 | 3.856 | 0.67 | 1.593 | 68.62 |
| 13 | 9.207 | 0.35 | 1.904 | 31.32 |
| 14 | 2.906 | D3 | | |
| 15* | −52.583 | 1.82 | 1.531 | 56.50 |
| 16* | −10.601 | D4 | | |
| 17 | infinity | 0.21 | 1.517 | 64.20 |
| 18 | infinity | 0.10 | | |
| 19 | infinity | 0.50 | 1.517 | 64.20 |
| 20 | infinity | D5 | | |
| 21 | infinity | D6 | | |

TABLE 8

| | Wide Angle | Middle | Telephoto |
|---|---|---|---|
| | Position | Position | Position |
| D1 | 0.67 | 16.48 | 19.42 |
| D2 | 13.64 | 1.34 | 0.40 |
| D3 | 3.63 | 17.43 | 16.65 |
| D4 | 3.83 | 2.34 | 2.32 |
| D5 | 0.53 | 0.53 | 0.53 |
| D6 | −0.02 | 0.01 | −0.02 |

TABLE 9

| Surface | K | A | B | C | D |
|---|---|---|---|---|---|
| 3 | 0.000000 | 5.349059E−06 | 1.348747E−08 | −1.645811E−10 | 0.000000E+00 |
| 6 | 1.000000 | 1.265567E−03 | 4.292597E−05 | −7.418682E−07 | 3.832527E−08 |
| 7 | −5.800000 | −9.323921E−04 | 2.751713E−05 | 2.549727E−07 | 1.244549E−08 |
| 10 | 1.000000 | 5.016918E−04 | 1.638303E−05 | 9.685333E−06 | 0.000000E+00 |
| 11 | 1.000000 | 8.685387E−04 | −4.329650E−05 | 1.435813E−05 | 0.000000E+00 |
| 15 | 0.000000 | 4.646245E−04 | 1.037705E−04 | 4.100029E−06 | −2.828229E−08 |
| 16 | −10.000000 | 2.634726E−04 | −1.011720E−04 | 3.524454E−06 | 1.684244E−08 |

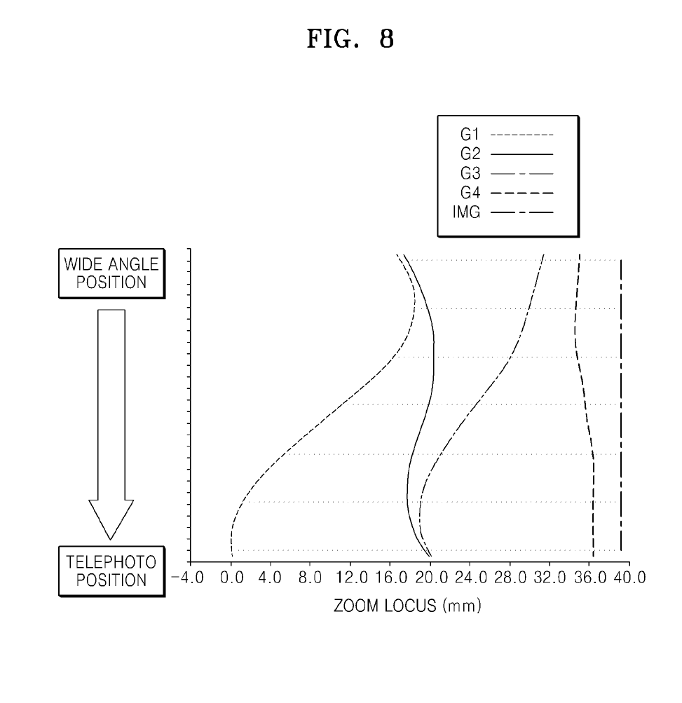

FIG. 8 is a diagram illustrating movement trajectories of each lens group of the zoom lens 103 of FIG. 7 during zooming.

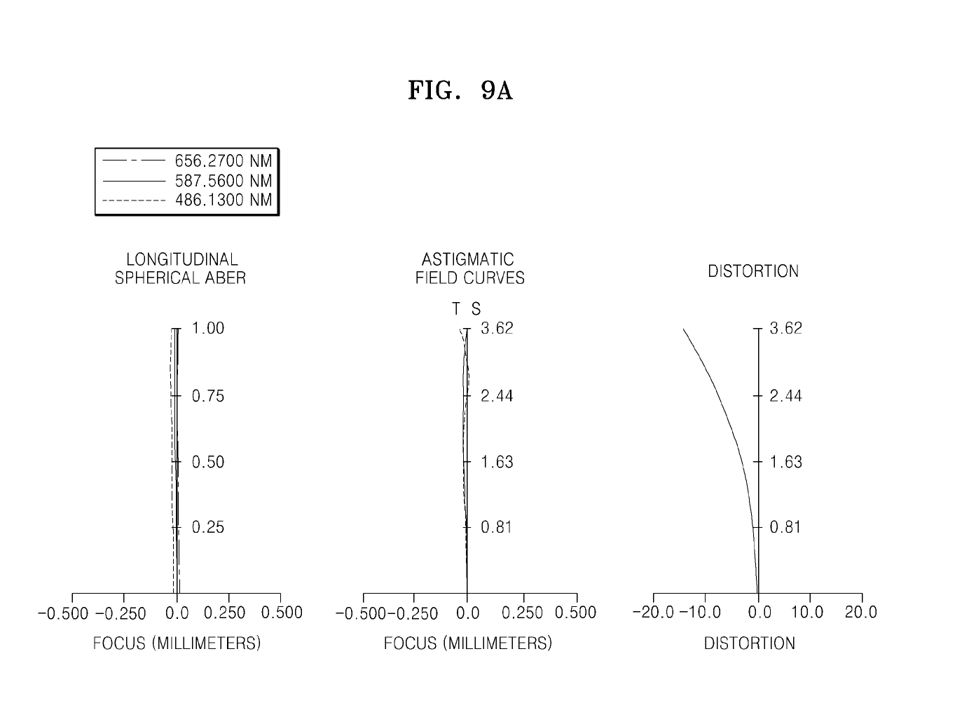

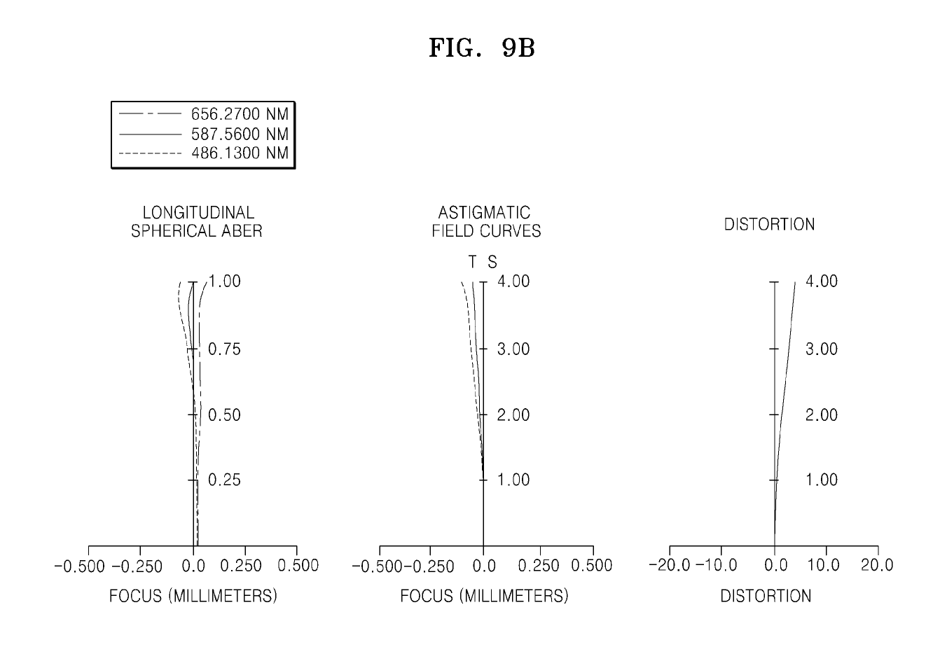

FIGS. 9A and 9B are diagrams illustrating longitudinal spherical aberrations, astigmatic field curvatures, and distortion aberrations of the zoom lens 103 of FIG. 7 in the wide angle position and the telephoto position.

### Fourth Embodiment

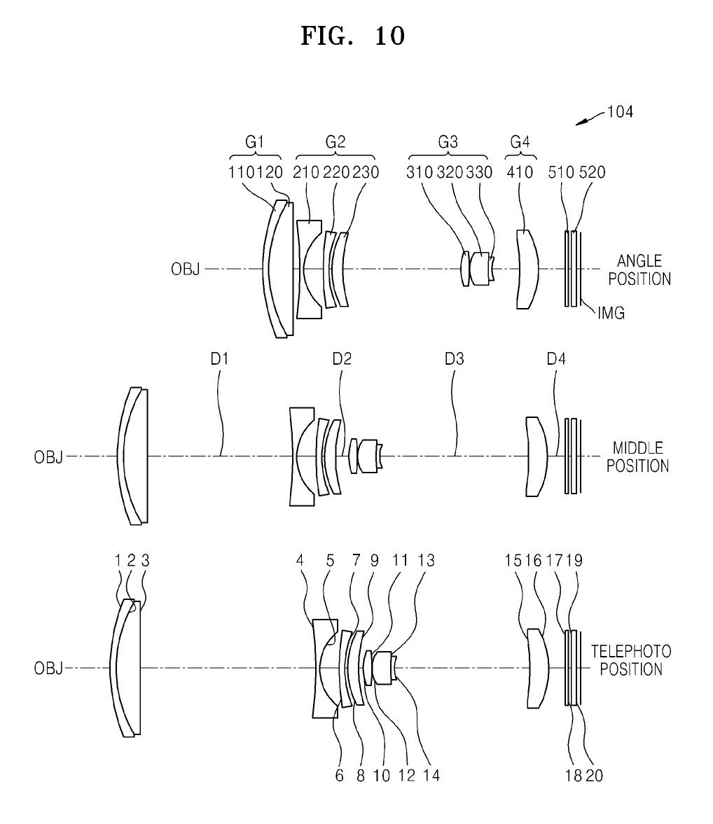

FIG. 10 illustrates diagrams of optical arrangements of the zoom lens 104 in a wide angle position, a middle position, and a telephoto position, according to another embodiment.
f; 4.41˜35.48˜44.17 Fno; 3.25˜6.85˜6.63 2ω; 84.08˜12.21˜9.76

TABLE 10

| | Radius of | Thickness or | Refractive | Abbe's |
|---|---|---|---|---|
| Surface | Curvature (R) | Distance | Index (nd) | Number (Vd) |
| 1 | 17.992 | 0.65 | 1.935 | 27.75 |
| 2 | 13.974 | 2.65 | 1.553 | 71.68 |
| 3* | −332.141 | D1 | | |
| 4 | −34.371 | 0.40 | 1.804 | 46.50 |
| 5 | 5.747 | 1.83 | | |
| 6* | 21.212 | 0.40 | 1.583 | 58.90 |
| 7* | 8.869 | 0.10 | | |
| 8 | 9.594 | 1.23 | 2.003 | 19.32 |
| 9 | 21.100 | D2 | | |
| 10*(STOP) | 5.925 | 1.41 | 1.497 | 81.56 |
| 11* | −12.073 | 0.10 | | |
| 12 | 4.033 | 1.86 | 59.282 | 68.62 |
| 13 | 9.791 | 0.35 | 1.904 | 31.32 |
| 14 | 3.171 | D3 | | |
| 15* | −105.257 | 1.90 | 1.531 | 56.50 |
| 16* | −6.500 | D4 | | |
| 17 | infinity | 0.21 | 1.517 | 64.20 |
| 18 | infinity | 0.10 | | |
| 19 | infinity | 0.50 | 1.517 | 64.20 |
| 20 | infinity | D5 | | |
| 21 | infinity | D6 | | |

TABLE 11

| | Wide Angle | Middle | Telephoto |
|---|---|---|---|
| | Position | Position | Position |
| D1 | 0.84 | 16.86 | 19.45 |
| D2 | 13.53 | 1.56 | 0.40 |
| D3 | 3.77 | 16.47 | 15.69 |
| D4 | 2.74 | 2.34 | 2.32 |
| D5 | 0.53 | 0.53 | 0.53 |
| D6 | −0.02 | 0..027 | −0.02 |

TABLE 12

| Surface | K | A | B | C | D |
|---|---|---|---|---|---|
| 3 | 0.000000 | 6.194785E−06 | 5.374673E−09 | −7.624027E−11 | 0.000000E+00 |
| 6 | −1.000000 | −2.252686E−03 | 9.967385E−05 | −1.799960E−06 | 5.282330E−08 |
| 7 | −5.800000 | −1.748944E−03 | 8.132158E−05 | −8.222034E−07 | 3.734879E−09 |
| 10 | −1.000000 | 1.142552E−03 | 4.342331E−05 | 3.819623E−05 | 0.000000E+00 |
| 11 | −1.000000 | 1.765903E−03 | 4.060490E−05 | 4.751209E−05 | 0.000000E+00 |
| 15 | 0.000000 | 8.312505E−04 | −1.087274E−04 | 7.850656E−06 | −2.805160E−07 |
| 16 | −10.000000 | −1.344052E−03 | 4.148469E−05 | 8.475289E−07 | −1.262278E−07 |

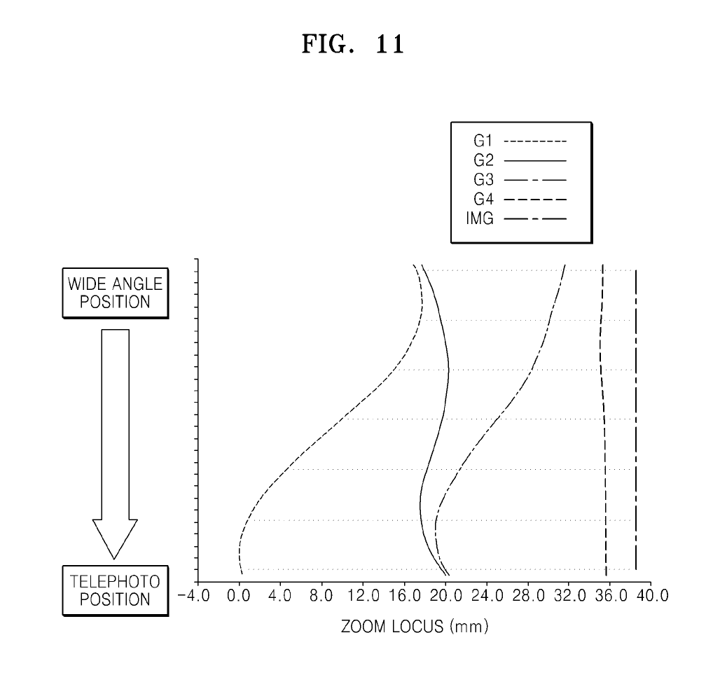

FIG. 11 is a diagram illustrating movement trajectories of each lens group of the zoom lens 104 of FIG. 10 during zooming.

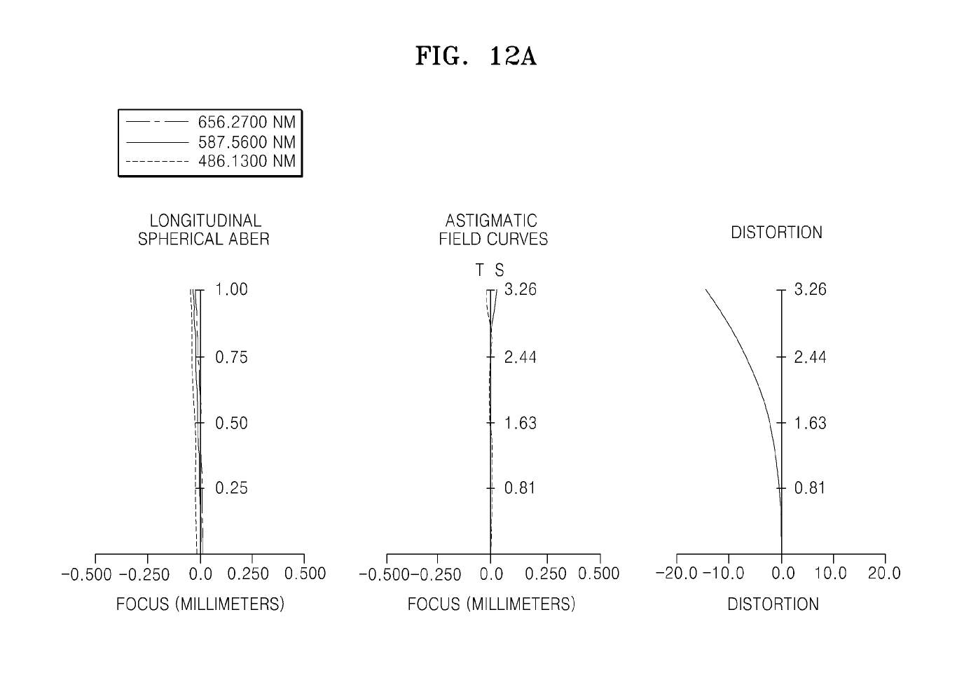

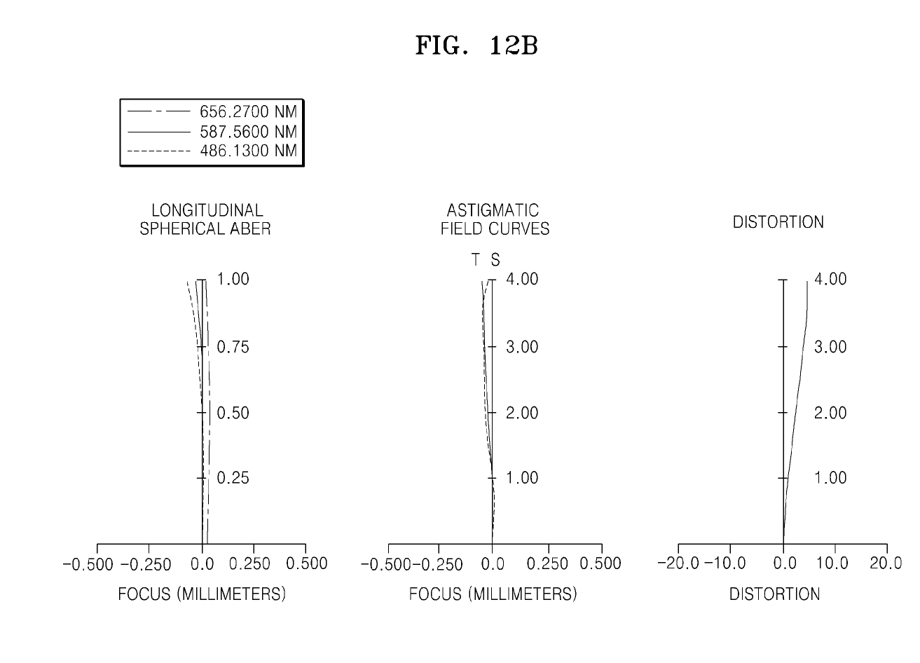

FIGS. 12A and 12B are diagrams illustrating longitudinal spherical aberrations, astigmatic field curvatures, and distortion aberrations of the zoom lens 104 of FIG. 10 in the wide angle position and the telephoto position.

Table 13 below shows that the zoom lenses 101 through 104 satisfy the above conditions.

TABLE 13

| | | First | Second | Third | Fourth |
|---|---|---|---|---|---|
| Condition | | Embodiment | Embodiment | Embodiment | Embodiment |
| (1) | 60 ≦ Vd3 | 71.680 | 71.680 | 61.251 | 81.560 |
| (2) | 2.9 ≦ f4/fw ≦ 5.6 | 3.715 | 3.580 | 5.547 | 2.918 |
| (3) | 4.5 ≦ Tol/(ft/fw) ≦ 5.5 | 4.609 | 4.732 | 5.206 | 5.2045 |
| (4) | 20 ≦ Pvd-Nvd | 27.542 | 43.930 | 42.550 | 43.930 |
| (5) | 2.0 ≦ Nd2 | 2.104 | 2.003 | 2.003 | 2.003 |

According to the embodiments, a zoom lens having high magnification and a miniaturized structure is provided. Also, since a lens shape suitable for using a low-priced material (e.g., plastic) is suggested, the zoom lens may be produced at a low cost. The zoom lens according to one or more embodiments may be employed in any one of various types of imaging apparatuses, together with an image pickup device that converts an optical image formed by the lens system to an electric signal.

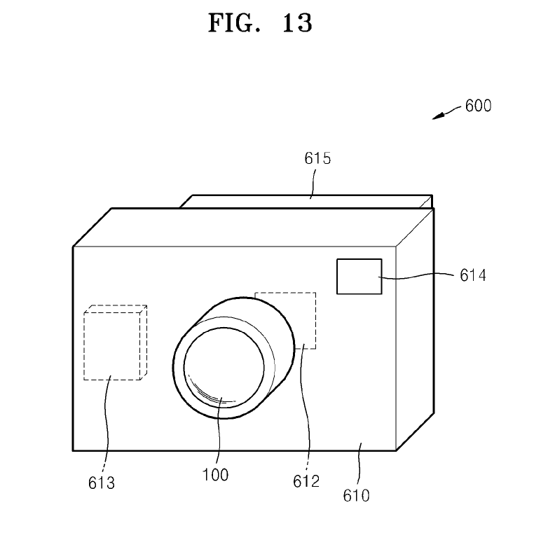

FIG. 13 is a diagram of an imaging apparatus 600, according to an embodiment. The imaging apparatus 600 includes a housing 610, a zoom lens 100, and an image pickup device 612 for converting an optical image formed through the zoom lens 100 to an electric signal. The zoom lens 100 may be any one of the zoom lenses 101 through 104 described above.

The imaging apparatus 600 may also include a storage unit 613 for storing information corresponding to a subject image that is photoelectric-converted by the image pickup device 612, and a viewfinder 614 for observing the subject image. Also, the imaging apparatus 600 may include a display unit 615 on which the subject image is displayed. In FIG. 13, the viewfinder 614 and the display unit 615 are separately included, but alternatively, the imaging apparatus 600 may only include the display unit 615 and not the viewfinder 614. As such, the imaging apparatus 600 shown in FIG. 13 is only an example, and the zoom lens 100 may be applied to any one of various optical devices as well as a camera.

As described above, by applying a zoom lens according to one or more embodiments to an imaging apparatus, such as a digital camera, an optical device having excellent optical performance and a miniaturized structure may be achieved.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A zoom lens comprising, in an order from an object side to an image surface side:
a first lens group having positive refractive power and comprising a negative lens and a positive lens;
a second lens group having negative refractive power and comprising a negative lens having a meniscus shape concave toward the image surface side;
a third lens group having positive refractive power and comprising an aspherical lens having at least one aspherical surface; and
a fourth lens group having positive refractive power,
wherein, during zooming from a wide angle position to a telephoto position, the first through fourth lens groups all move, the third lens group moves from the image surface side to the object side and then back to the image surface side, and the zoom lens satisfies the following conditions:
60≦Vd3; and
2.9≦f4/fw≦5.6,
wherein Vd3 denotes an Abbe's number of the aspherical lens of the third lens group, f4 denotes a focal length of the fourth lens group, and fw denotes a total focal length of the zoom lens in the wide angle position.

2. The zoom lens of claim 1, further satisfying the following condition:
4.5≦ToI/(ft/fw)≦5.5,
wherein ToI denotes a distance from a lens surface of the first lens group closest to the object side to a lens surface of the third lens group closest to the image surface side in the telephoto position, ft denotes a total focal length of the zoom lens in the telephoto position, and fw denotes the total focal length of the zoom lens in the wide angle position.

3. The zoom lens of claim 1, further satisfying the following condition:
20≦Pvd−Nvd,
wherein Pvd denotes an Abbe's number of the positive lens of the first lens group and Nvd denotes an Abbe's number of the negative lens of the first lens group.

4. The zoom lens of claim 1, wherein the negative lens having the meniscus shape of the second lens group is formed of a plastic material.

5. The zoom lens of claim 1, wherein the second lens group further comprises a positive lens that satisfies the following condition:
2.0≦Nd2,
wherein Nd2 denotes a refractive index of the positive lens of the second lens group.

6. The zoom lens of claim 1, wherein the second or the third lens group is configured as a shift lens group that moves in a direction perpendicular to an optical axis for hand shake compensation.

7. The zoom lens of claim 1, wherein the third lens group further comprises a cemented lens formed by cementing two lenses together, each lens having a meniscus shape convex toward the object side.

8. The zoom lens of claim 1, wherein the fourth lens group comprises a lens formed of a plastic material.

9. The zoom lens of claim 1, wherein the positive lens and the negative lens of the first lens group form a cemented lens.

10. The zoom lens of claim 1, wherein the second lens group further comprises an aspherical lens having negative refractive power.

11. The zoom lens of claim 1, wherein the fourth lens group comprises an aspherical lens having positive refractive power.

12. The zoom lens of claim 11, wherein the aspherical lens of the fourth lens group has a meniscus shape concave toward the object side.

13. A zoom lens comprising, in an order from an object side to an image surface side:
a first lens group having positive refractive power and comprising a negative lens and a positive lens;
a second lens group having negative refractive power and comprising a negative lens having a meniscus shape concave toward the image surface side;
a third lens group having positive refractive power; and
a fourth lens group having positive refractive power,
wherein, during zooming from a wide angle position to a telephoto position, the first through fourth lens groups all move, the third lens group moves from the image surface side to the object side and then back to the image surface side, and the zoom lens satisfies the following condition:
2.9≦f4/fw≦5.6; and
4.5≦ToI/(ft/fw)≦5.5,
wherein f4 denotes a focal length of the fourth lens group, ToI denotes a distance from a lens surface of the first lens group closest to the object side to a lens surface of the third lens group closest to the image surface side in the telephoto position, ft denotes a total focal length of the zoom lens in the telephoto position, and fw denotes a total focal length of the zoom lens in the wide angle position.

14. The zoom lens of claim 13, further satisfying the following condition:
20≦Pvd−Nvd,
wherein Pvd denotes an Abbe's number of the positive lens of the first lens group and Nvd denotes an Abbe's number of the negative lens of the first lens group.

15. The zoom lens of claim 13, wherein the second lens group further comprises a positive lens that satisfies the following condition:
2.0≦Nd2,
wherein Nd2 denotes a refractive index of the positive lens of the second lens group.

16. The zoom lens of claim 13, wherein the second or the third lens group is configured as a shift lens group that moves in a direction perpendicular to an optical axis for hand shake compensation.

17. The zoom lens of claim 13, wherein the third lens group comprises an aspherical lens having positive refractive power and at least one aspherical surface.

18. The zoom lens of claim 17, wherein the third lens group further comprises a cemented lens formed by cementing two lenses together, each lens having a meniscus shape convex toward the object side.

19. The zoom lens of claim 13, wherein the negative lens and the positive lens of the first lens group form a cemented lens.

20. The zoom lens of claim 13, wherein the second lens group further comprises an aspherical lens having negative refractive power.

21. The zoom lens of claim 13, wherein the fourth lens group comprises an aspherical lens having positive refractive power.

22. The zoom lens of claim 21, wherein the aspherical lens of the fourth lens group has a meniscus shape concave toward the object side.

23. An imaging apparatus comprising:
the zoom lens of claim 1; and
an image pickup device that converts an optical image formed by the zoom lens to an electric signal.
